(19) United States
(12) Patent Application Publication
(10) Pub. No.: US 2009/0282735 A1
(43) Pub. Date: Nov. 19, 2009

(54) Sustainable new water production system

(75) Inventors: Robert B. Fien, Sacramento, CA (US); Robert L Campbell, Rancho Murietta, CA (US)

Correspondence Address: MARK C. JACOBS, ESQ., 3033 EL CAMINO AVE., SACRAMENTO, CA, 95821, US

(73) Assignee: Campbell Applied Physics

(21) Appl. No.: 12/453,580

(22) Filed: May 14, 2009

Related U.S. Application Data
(60) Provisional application No. 61/127,709, filed on May 15, 2008.

(51) Int. Cl. A01G 29/00; C02F 1/58; C01B 3/38; C01B 5/00

(52) U.S. Cl. 47/48.5; 210/251; 252/373; 423/580.1

(57) ABSTRACT

A system, having three independent subsystems, each yielding useful products for society. The CBM produced water, starting ingredient for subsystem one, yields LNG, and useable water. Subsystem two produces syngas from agricultural products irrigated by subsystem one water. This syngas is used in subsystem three to produce more potable water at a second plant. CBM produced water is separated into two streams of methane, for distribution as LNG and for use in a fuel cell to power a first desalination plant that uses the CBM produced water to create potable water and irrigation water. Fast growing crops, are irrigated by water from subsystem one, to serve as a cost effective source of raw material for a gasification plant to produce syngas; which syngas can be publically distributed, or used as the fuel for the third subsystem; namely a seawater desalination plant to produce potable water at a second site.

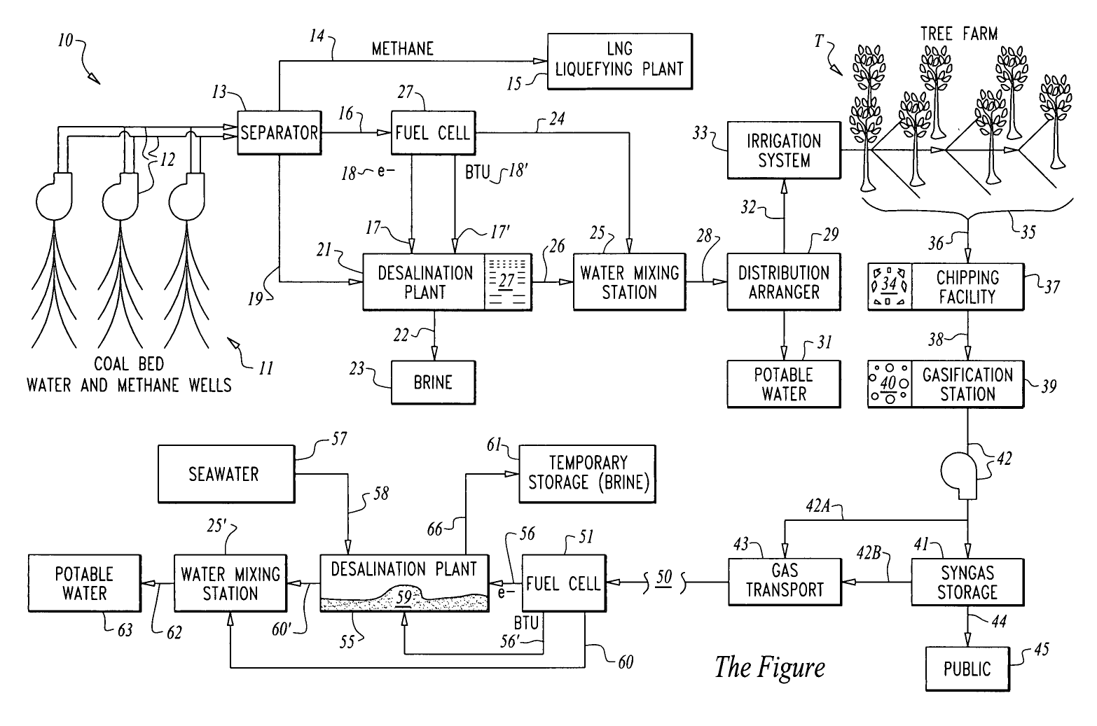

### RELATIONSHIP TO PRIOR APPLICATIONS

This application claims priority from U.S. Provisional Application Ser. No. 61/127,709 which was filed on May 15, 2008 in the names of Fien and Campbell, attorney docket #1688 Pro.

### FIELD OF INVENTION

This invention relates to a process wherein coal bed methane water is turned into both potable drinking water and water to be used for irrigation of a specific type of tree or crop, and the methane is converted into liquified natural gas which is used as a fuel. The specific tree or crop chosen for irrigation is one that is suitable itself for being converted into syngas a.k.a. SNG, for use locally for industry and commercially; as well as for use at a distant location to power a fuel cell to provide the power to operate a water desalination plant to provide additional potable water. What was once considered to be a hazardous waste product,—coal bed methane produced water—, can now serve as the basis for producing new energy and for potable water production.

### BACKGROUND OF THE INVENTION

Under the current paradigm, coal bed methane produced water is often deemed a hazardous waste and is treated as such by many of the advanced nations of the world. In contrast, in accordance with the invention of this application, coal bed methane produced water is seen as the foundation of a mode of producing potable water and as a new source of energy for today's energy starved world. The term sustainable is used because part of the water obtained from what has been deemed waste can be used to irrigate a regenerate-able crop, which when harvested can be treated and ultimately used to produce more potable water for a thirsty populous. One such plant is found in Australia and can also be purchased in the USA. It is the hybridized Paulownia tree. Other trees found in other countries can serve the same function.

As used in this application, the term “pipes and pumps” is meant to describe a mode of moving fluid, which may or may not include valving. The term “line” shall be deemed synonymous to the term “pipes and pumps.” Sometimes the phrase “pipes and pumps” can be used to refer to piping without the need for a pump, since it is within the skill of the art to determine whether a pump is needed in any given situation.

### BRIEF DESCRIPTION OF THE FIGURE

The single FIGURE is a schematic diagram of the three aspects of the system of this invention.

### SUMMARY OF THE INVENTION

A three part system, formed of three independently operable subsystems each of which subsystems yields useful products for society. The system uses coalbed methane produced water as its starting raw material In the first subsystem, the products are LNG, potable water and irrigation water. The second subsystem produces syngas for local consumption and/or for further use in the third subsystem to produce potable water at a second plant from seawater. Coal bed methane produced water is separated into two streams of methane, one for distribution as LNG and second for use in a fuel cell to power a desalination plant that uses the water from the CBM produced water to create potable water and irrigation water.

By the careful selection of specific fast growing crops, which can be irrigated by the water from the first subsystem, a cost effective source of raw material for a gasification plant to produce syngas can be had.

The syngas from the second subsystem can be publically distributed, or used as the fuel for the third subsystem which is a seawater desalination plant to produce potable water at a second site.

It is one object therefore of this invention to provide a sustainable mode for the production of potable water.

It is another object of the invention to provide a process for preparing water for the irrigation of fast growing trees and crops.

It is a third object of this invention to use the fast growing vegetable matter as the fuel source for the production of potable water from sea water.

It is a fourth object of this invention to utilize fast growing crops and trees as a source for the manufacture of syngas.

Other objects of the invention will in part be obvious and will in part appear hereinafter.

The invention accordingly comprises the system possessing the construction, combination of elements and arrangement of parts, and the process and its multiple steps, and the product thereof, all of which are exemplified in the following detailed disclosure, and the scope of the application of which will be indicated in the claims.

### DESCRIPTION OF THE PREFERRED EMBODIMENT

Introduction

The discussion of the invention commences with a review of the three parts of the FIGURE. The process here involved is really divided into three aspects, the first of which ends at box, 31, the creation of potable water, and the pretty forest of trees T. The second aspect of the invention commences at box bracket, 35, segregated from trees, T. It is the location where the utilization of the sustainable forest commences. In this aspect the designated variety(s) of trees and especially the fast growing hybridized Paulownia tree are chipped down to usable particles for introduction into a gasification facility, 39, to provide syngas as the output product.

The third aspect of the invention pertains to the use of the syngas produced preferably from the nearby site, to operate a distant desalination plant to prepare additional potable water.

Let us now begin the discussion of this invention. Coal bed methane wells are well known. They are found in various parts of the world where coal is mined. Three such countries that have coal bed methane produced water, are the United States, especially in Alabama, Montana, and New Mexico, as well as Great Britain and Australia. Coal beds contain many fractures and pores that can contain and transmit large amounts of water to the surface in conjunction with natural gas. In fact it is this water that creates pressure to keep the methane adsorbed to the surface of the coal. The natural gas is almost 100% methane, CH₄ The amount of water produced and the ratio of gas to water varies from site to site for many reasons such as but not limited to the depth of the CBM—coal bed methane—, the type of coal, and the duration of CBM production among others.

Unlike water produced in oil recovery, CBM produced water is not re-injected back into the deposit to help with recovery. The co-produced water must be put to limited beneficial purposes, or disposed of. The choice depends on the composition of the water, specifically the TDS or total dissolved solids, the pH, and the concentration of dissolved metals and radium. And the SAR-[sodium absorption rate.] Thus even though it is water based, coal bed methane produced water can be explosive and is often treated as a hazardous waste product of the coal mining process. This mixture of water and methane designated 11 is the starting material of this invention, 10 in the FIGURE. For more information on CBM produced water, readers are referred to the US Geological Survey, located in Denver Colo.

As shown in The FIGURE, the coal gas water, 11, is collected and moved by pipes and pumps, 12, to a separator, 13. The hardware and technology to separate the methane from the water is known to the art and is available in the marketplace. The reader should note the entry of the two streams, gas and water, into the separator, 13. The bulk of the methane is delivered by pipes and pumps, 14, to a gas liquefying plant, 15, to prepare LNG a.k.a. liquified natural gas, fuel for domestic, industrial and commercial purposes.

Some of the coal bed gas stream of methane is delivered by pipes and pumps, 16, from the separator 13 to a fuel cell, 27. Here water, formed as a product of the fuel cell emerges via line, 24, (a pipes and pump subsystem) to a water mixing station, 25.

Backing up momentarily, it is seen that in the fuel cell 27, part of the methane aspect of the coal gas mixture is converted into energy and heat which are expressed, as shown in the FIGURE denoted as “e-” and “BTU” respectively. The two parts of the piping system to move the heat and energy created, are designated 18 and 18′ respectively. The heat and energy, 17 and 16 17′, respectively are used to power and operate a desalination plant, 21.

Line, 22, is the exit line or piping from the desalination plant, 21, which delivers the brine, 23, for re-delivery by known means to the ocean or for concentration to salt, both by known technologies.

As to the type of desalination plant that may be employed at box 21 of the FIGURE, it is known that R.O., or reverse osmosis, is a power hungry procedure. Much power is needed to operate the high pressure pumps associated with this process. If a stable back-up source of power is not available to supplement the fuel cell heat and energy, it is recommended that a distillation plant be employed. This is because if there is only a little bit of power, relatively speaking, a little bit of potable water can be prepared and if a large source of power is available, the plant can be run to its maximum capacity to provide a high yield of potable water. One type of desalination plant one might consider is a plant that utilizes ozone capacitive deionization. Such a plant is disclosed and claimed in an application filed by inventor Robert Campbell of this application.

Note the three output lines from the separator. Two are gas and the third is the water. Output line 19 is also the input line to the desalination plant, 21. This pipeline, 19, brings impure water from the gas separator, 13, to the desalination plant, 21, to be met with the heat 17 and energy 17′ from the fuel cell. The output water, 27, moves in pipes and pumps, 26, to the mix station, 25, where the joint stream of potable water moves along pipes and pumps, 28, to the distribution arranger station, 29.

The mix station, 25, is merely a location where two sources of potable water come together on the intake side and exit as one stream. The first source being from the fuel cell via pipes and pump line 24, while the second source is from the just discussed desalination plant. Here at the mix station, the management decides the proportion of the potable water to be delivered by line, 30, to the water storage for future delivery infrastructure, 31. What ever amount of potable water is not sent to storage and delivery, 31, is used to irrigate the trees designated T and is delivered by the irrigation system, 33. Irrigation systems are well known to the art and it is beyond the scope of this invention to delve into the types of irrigation systems used on ranches and at plant nurseries. Any suitable water delivery system 33 connected to the distribution arranger 29, may be employed.

While any tree, or bush capable of easily being transformed into wood chips by a chipper, 37, may be employed for the gasification process—such as the trees T, to be watered by irrigation system, 33, our preference is the hybrid Paulownia tree. Other fast growing trees but nearly as fast growing as the Paulownia tree are the tulip poplar, the ginkgo and the varieties of crepe myrtle. The chosen trees or crop is harvested conventionally and delivered to a plant for chipping/chopping or other processing as needed, for the crop to be used for gasification.

The Paulownia tree is a deciduous tree often called the Empress tree, and is a native of China. It is somewhat similar to the Catalpa tree, in both growth habit and leaf configuration. They grow quickly to a height between 40 and 50 feet and their branches can develop a span of the same distance. Forests of these trees are quite striking visually due to both the large leaves which can be as long as 12 inches coupled with its lilac blue to lavender spotted flowers. But it is their fast growth that makes them of special interest to this invention.

The Paulownia tree is considered to be America's fastest growing shade tree. It can reach 18 feet high in the first growing season and 25 feet by the third season. They can grow in full or part shade in growing zones 5-11. When mature they can reach 40-50 feet high and 30-40 feet in width, and have good drought tolerance. Since they lose their leaves in winter, they allow the sunlight to bath the property, yet in summer provide cooling shade over wide areas. Seedlings that range from about eight inches tall to 1 foot tall trees can be purchased on the internet from several nurseries and from the World Paulownia Institute for as little as $3.00 US each.

Having spoken a bit about the Paulownia tree, it is easy to understand why it stands out as being suitable for this invention. When the trees reach a suitable height, they can be trimmed or cut down and delivered by a transportation system such as trucks, 36, from a harvesting facility, 35, to a chipping plant, 37, at which chipping plant, multiple high speed saws will form wood chips from the trunks and limbs of the Paulownia or other chosen trees. This is the first step of the second aspect of this invention. The chips are transported by truck, train, or other second transportation system, designated 38, to a gasification station, 39, for the preparation of syngas a.k.a. synthetic natural gas. This product is shown by the bubbles, 40, seen in block 39 of the FIGURE.

The syngas gas is delivered by a third transportation system, namely pipes and pumps, or perhaps truck, 42, to a temporary or long term storage site, 41, which is a syngas storage facility.

Let us now quickly review the completed first and second aspects of this invention. The first aspect of this system started with CBM water,and resulted in LNG being separated out. The mixture of coal gas and water was separated at 13, and divided into two streams. The methane gas s liquified at station, 15, to became a commercial product. Part of the methane that was separated out was delivered to the fuel cell to create heat and energy for the operation of the desalination station, which in turn uses the separated water from separator 13, with the output water from the desalination station being both potable and of irrigation quality suitable for fast growing trees The water from the desalination plant joins the fuel cell permeate to be further treated as may be necessary under local law, and not shown in the FIGURE, and is delivered to the Distribution Center, 29, where some of the water goes to irrigate the specified Paulownia or other trees while much of the water goes to a potable water facility designated 31, for use by the community. So we see that the formerly hazardous waste has now become drinking water and irrigation water for the trees, T, and perhaps other crops, not shown.

In review, the second aspect of the system, was the trimming or cutting down of the fast growing renewable trees from the tree farm, the chipping of the wood and then the gasification step to form more syngas which can be stored at facility 41.

The discussion continues with the third aspect; namely, what to do with the syngas generated in the second aspect discussed previously, and now stored at facility 41.

While the presence of a temporary storage facility, 41, has been noted as the destination for pipes and pumps 42, it is also recognized that such storage facility 41 can become a long term storage facility for ultimate distribution of the gas by distribution means 44 to an energy seeking public 45.

Furthermore, it is seen by that such facility 41 can be either maintained or eliminated and that the syngas can be delivered to a second fuel cell, 51 starting with alternate pipes and pump 42A or from the syngas storage facility by pipes and pumping 42B. One can operate on either assumption for the third aspect of this invention, as concerning the existence of the syngas storage facility 41. Either way, the next step for the syngas, is for the gas to be taken by a fourth transportation system, designated 43, to a fuel cell facility, 51.

The Reader should note the open space 50 between the two squiggly lines that is employed symbolically to designate that the fuel cell can be either locally owned and operated, or operated at a distant location. A close-by location is preferred, in order to keep operating costs down. The fourth transportation means, previously designated 43, can be a pipeline, truck, railcar, etc. The fuel cell, 51, needs to be of a type that internally reforms syngas such as a molten carbonate fuel cell or a phosphoric acid fuel cell. Such a fuel cell creates energy and heat from its syngas input fuel to operate the second desalination plant, 55. As has been noted, the products of the operation of the earlier discussed fuel cell and this fuel cell are water shown being delivered by pipeline, 61, to mix station 25′ and heat and energy. The heat, expressed as BTU and energy are shown being delivered to run the desalination plant by designators 56′ and 56, respectively.

Seawater, 57, enters the desalination plant 55, via pipes and pumps, 58, which plant separates out the brine 59, and delivers it by pumps and pipes, 60, to a reentry point of temporary storage, 61, for reintroduction into a nearby water body, or for evaporation and collection of salt as is known in the art. Such an evaporation pond for salt collection can be seen at the inner end of San Francisco Bay in California.

Meantime, water in pipeline 60′ from the fuel cell and water from the desalination plant in piping 60 are mixed together at station, 25′, which is the same type of conventional mix station as designator 25. From there, the combined potable waters are moved from 25′ to a storage or bottling facility or water distribution system designated 63.

It is thus seen that the coal bed methane gas produced water has helped to provide potable water to populations in possibly two very geographically separated areas of a country, or perhaps even in different countries as well as to provide water for a tree farm and perhaps for other crops as well.

While the process as set forth above calls for “trees,” and preferably Paulownia trees due to their specific characteristics, other suitable sustainable crops such as perhaps switch grass may be used to produce the syngas. Of course, a procedure other than chipping might be required to prepare the starting material for syngas manufacture depending upon the agricultural product(s) employed as starting material.

What was once deemed to be a hazardous waste product of the coal industry has found respectability and new life as a potable and I irrigation water source, and as a precursor for syngas. And lastly, in this era of measured carbon footprints, it is seen that the only carbon dioxide produced by this system is from a renewable source; namely the trees or crops which consume carbon dioxide. Thus this system as an entirety approaches being carbon neutral.

Since certain changes may be made in the above described multi aspect system, without departing from the scope of the invention herein involved, it is intended that all matter contained in the above description and shown in the accompanying drawing, shall be interpreted as illustrative and not in a limiting sense.

What is claimed is:

1. A process for producing potable water which system comprises:
a] separating coal bed methane produced water into two streams comprising methane and water,
b] introducing methane from the methane stream into a fuel cell to produce heat and energy,
c] introducing water from the water stream into a desalination plant,
d] using the heat and energy from the fuel cell to separate the salts from the water stream in the desalination plant,
e] delivering non-brine bearing water to a distribution point.

2. The process of claim 1 further including the step of using the non-brine bearing water to irrigate fast growing crops for further use.

3. A process for preparing syngas from coal bed methane produced water which comprises:
a] separating coal bed methane produced water into two streams comprising a methane stream and a water stream,
b] introducing methane from the methane stream into a fuel cell to produce heat and energy,
c] introducing water from the water stream into a desalination plant,
d] using the heat and energy produced from the fuel cell to separate the salts from the water stream in the desalination plant, to produce non-brine bearing water,
e] using the non-brine bearing water to irrigate fast growing trees and crops;
f] harvesting the fast growing trees and crops and processing them for use in a gasification plant;
g] gasifying the fast growing trees and crops to prepare syngas.

4. A process for preparing potable water from seawater which comprises
a] introducing syngas prepared from the gasification of fast growing trees and crops into a fuel cell
b] using the heat and energy from the fuel cell to operate a seawater desalination plant;
c] introducing sea water into the desalination plant;
d] separating out the brine from the sea water to yield potable water.

5. The process of claim 4 wherein water obtained as a by product from the operation of the fuel cell is mixed with the potable water from the desalination plant.

6. A process for using vegetable matter for preparing potable water from seawater which process comprises:
a] harvesting fast growing trees and crops and processing them for use in a gasification plant;
b] gasifying the fast growing trees and crops to prepare syngas.
c] a] introducing syngas prepared from the gasification of the fast growing trees and crops into a fuel cell
d] using the heat and energy from the fuel cell to operate a seawater desalination plant;
e] introducing sea water into the desalination plant;
f] separating out the brine from the sea water to yield potable water.

7. The process of claim 4 wherein water obtained as a by product from the operation of the fuel cell is mixed with the potable water from the desalination plant.

8. A process for purifying coal bed methane produced water and for preparing potable water at a site distant from the CMB produced water situs, which process comprises:
a] separating coal bed methane produced water into two streams comprising methane stream and a water stream,
b] introducing methane from the methane stream into a fuel cell to produce heat and energy,
c] introducing water from the water stream into a desalination plant,
d] using the heat and energy from the fuel cell to separate the salts from the water stream in the desalination plant, to produce potable water,
e] using the potable water just prepared to irrigate fast growing trees and crops;
f] ] harvesting fast growing trees and crops and processing them for use in a gasification plant;
g] gasifying the fast growing trees and crops to prepare syngas.
h] a] introducing syngas prepared from the gasification of the fast growing trees and crops into a fuel cell,
I] using the heat and energy from the fuel cell to operate a seawater desalination plant;
j] introducing sea water into the desalination plant;
k] separating out the brine from the sea water to yield potable water.

9. The process of claim 8 further including the step of mixing the water obtained as a by product from the fuel cell associated with the sea water desalination plant with the water potable water produced from the sea water desalination plant.

10. The process of claim 8 including the additional step of dehydrating the brine removed from the seawater desalination plant for collection of the salt.

11. A system for irrigating fast growing trees and crops for use of the trees and crops in a gasification plant, which system comprises
A] a coal bed methane produced water separator having two output streams to separate the methane from the water, the methane output stream being the input stream for a fuel cell, and the water output stream being the input stream for a desalination plant,
B] a fuel cell connected to said methane input stream;
C] a desalination plant connected to the said water input stream, and said plant also being operatively connected to said fuel cell for the powering of said plant; said plant having a water output means,
D] water distribution arranger means connected to the water output of said desalination plant, for the distribution of water to an irrigation means for fast growing trees and crops;
E] harvested tree and crop processing means for the preparation of raw material for a gasification plant, and
F] a vegetable matter gasification plant adapted to utilize fast growing tree and crop matter as its input for the preparation of syngas.

12. Potable water prepared by the process which comprises:
a] separating the methane from the impure water of coal bed methane produced water,
b] inputting the methane into a fuel cell to create heat and energy output,
c] inputting the separated impure water into a desalination plant which utilizes the heat and energy output from the fuel cell for its operation, and which plant has an output,
d] collecting the potable water from the output of the desalination plant for use by mankind.

13. Potable water prepared from seawater by a desalination plant, whose heat and energy comes from a fuel cell that utilizes syngas prepared by the process of chipping and cutting of fast growing trees and crops for use as raw material for a gasification plant whose output product is syngas.

14. The potable water of claim 13, wherein the fast growing trees and crops utilized in the chipping and cutting process for delivery to the gasification station to make syngas are Paulownia trees.
